(19) United States
(12) Patent Application Publication
(10) Pub. No.: US 2016/0014000 A1
(43) Pub. Date: Jan. 14, 2016

(54) METHOD AND DEVICE FOR ANALYZING EVENTS IN A SYSTEM

(71) Applicant: SIEMENS AKTIENGESELLSCHAFT, München (DE)

(72) Inventors: Joachim FROHLICH, Munich (DE); Stefan ROTHBAUER, Augsburg (DE)

(73) Assignee: SIEMENS AKTIENGESELLSCHAFT, München (DE)

(21) Appl. No.: 14/765,776

(22) PCT Filed: Dec. 16, 2013
(86) PCT No.: PCT/EP2013/076716

§ 371 Date: Aug. 4, 2015

(30) Foreign Application Priority Data
Feb. 5, 2013 (DE) 10 2013 201 831.2

(51) Int. Cl. H04L 12/26; H04L 29/08

(52) U.S. Cl. CPC H04L 43/0817; H04L 67/1097; H04L 43/04

(57) ABSTRACT

In a system having system components that communicate with one another internally by a common database and connected to a system environment of the system by at least one first interface of the system, events are analyzed by isolating a system component of the system from the system environment when an integrity component of the system detects the occurrence of a certain event in the system component. Then, the control of the isolated system component is transferred to an analysis component of the system by the integrity component. The analysis component establishes a communication connection to an external analysis unit by a second interface of the system and the external analysis unit analyzes the event that occurred in the isolated system component, based on the component data of the isolated system component that are stored in the common database of the system.

### CROSS REFERENCE TO RELATED APPLICATIONS

This application is the U.S. national stage of International Application No. PCT/EP2013/076716, filed Dec. 16, 2013 and claims the benefit thereof. The International Application claims the benefit of German Application No. 10 2013 201 831.2 filed on Feb. 5, 2013, both applications are incorporated by reference herein in their entirety.

### BACKGROUND

Described below is a method and a device for analyzing events which occur in a system, in particular an electronic system having system components which internally communicate with one another via a common database.

Systems, in particular electronic systems, may have a multiplicity of different system components. These system components may include, on the one hand, hardware components and, on the other hand, software components. Furthermore, system components may also be hardware components on which software is implemented. In safety-critical systems in particular, faulty system components are generally immediately disconnected if a fault occurs. However, the immediate disconnection of such system components results in a loss of data needed to analyze and narrow down the causes of the fault. If faults occur in a safety-critical electronic system, the entire faulty system or at least the affected system components is/are immediately disconnected in many applications. If the affected system has a redundant design and if a fault which can be assigned to one system component and can be restricted to the latter is detected, the affected faulty system component is disconnected and the affected system component is then either restarted in order to eliminate the fault and to test the system component and to change it to a defined state or the affected faulty system component is replaced with a functionally equivalent redundant system component of the electronic system. In both cases, a large portion of the required data, such as events or system states which resulted in the disconnection of the entire faulty system or at least the faulty system component, is lost after the disconnection and is no longer available for the purpose of analyzing and narrowing down the causes of the fault.

During the operation of an electronic system, important events and system states of the electronic system are logged in many known electronic systems, the logged events and system states or data subsequently being intended to provide information relating to possible causes of a fault. Examples of known electronic systems are so-called black boxes in aircraft or rail vehicles or so-called event logs on Microsoft Windows systems or system logs on UNIX systems. For reasons of space, such systems store only a selection of temporal data in a data window, for example the most recent N data records. Furthermore, in known systems, only those data which are suitable for documenting faults considered by a system developer of the system before use of the system are stored in a data memory. Therefore, maintenance engineers, for example, cannot analyze events which result or resulted in the failure of system functions if the possibility of the occurrence of a corresponding fault was not considered by the system developer during system development or the stored data are outside the relevant data window. Only the data or data records which have been recorded and are still available are available for analyzing a fault if the data memory itself is not affected by a fault. Therefore, it is not possible to check temporary system states of a system or system component which has been immediately disconnected in the event of a fault in known systems.

### SUMMARY

Therefore, described below are a method and a device for analyzing events, which method allows the fault which has occurred to be analyzed with respect to its cause even after the affected system components have been disconnected.

Described below is a method for analyzing events which occur in a system having system components which internally communicate with one another via a common database and are connected to a system environment of the system via a first interface of the system. In performing the method, a system component of the system is isolated from the system environment if an integrity component of the system detects the occurrence of a particular event in the system component. Then, the integrity component transfers control of the isolated system component to an analysis component of the system, which establishes a communication connection to an external analysis unit via a second interface of the system. Finally, the event which has occurred in the isolated system component is analyzed by the external analysis unit using the component data relating to the isolated system component which are stored in the common database of the system.

The system states and events recorded at the time at which a fault occurs are therefore retained using the method. As a result, the entire faulty system or at least the affected faulty system component continues to be available for analyses.

The method can be used during system development to test the system or to search for causes of faults as part of fault debugging. Furthermore, the method can be carried out while the system is being used in the field, that is to say during operative use of the system.

In one possible embodiment of the method, the analysis component of the system provides the external analysis unit with the component data relating to the isolated system component which are stored in the common database of the system via the communication connection which has been established for the purpose of analyzing the event which has occurred in the isolated system component.

In another possible embodiment of the method, the external analysis unit deactivates the isolated system component after the event which has occurred in the isolated system component has been analyzed.

In another possible embodiment of the method, the analysis component then writes definable component data relating to the affected system component to the common database of the system.

In another possible embodiment of the method, the external analysis unit causes the entire system or the affected system component to be restarted after the definable component data have been written to the common database of the system.

In another possible embodiment of the method, each system component of the system stores a data copy of the component data relating to all system components of the system, which component data are stored in the common database.

In another possible embodiment of the method, the integrity component continuously monitors the occurrence of an event in a system component of the system on the basis of the component data stored in the common database of the system.

In another possible embodiment of the method, the integrity component, if a particular event occurs in a system component of the system, isolates this system component from the system environment.

In another possible embodiment of the method, the integrity component keeps the isolated system component active, if possible, at least until analysis of the event which has occurred in the system component has been completed by the external analysis unit.

In another possible embodiment of the method, a system component of the system carries out write access only to its own component data relating to the respective system component inside the common database of the system.

In another possible embodiment of the method, a test component implemented in the system carries out both write access and read access to the component data relating to all system components of the system, which component data are stored in the common database of the system.

In another possible embodiment of the method, the analysis component of the system uses the test component of the system to carry out write and read access to component data relating to system components of the system, which component data are stored in the common database of the system.

In another possible embodiment of the method, the test component present in the system has a communication connection to an external test unit via the second interface of the system.

In another possible embodiment of the method, the test component, as a system component of the system, deliberately causes events in one or more system components of the system, which events are detected by the integrity component of the system.

In another possible embodiment of the method, the system components of the system control and/or monitor external components of the system environment of the system.

In another possible embodiment of the method, the external components of the system environment of the system have actuators and/or sensors which are connected to the first interface(s) of the system via a network and are controlled and/or monitored by system components of the system.

In another possible embodiment of the method, at least some of the system components of the system, including the integrity component, the analysis component and the test component, are software components which are implemented on one or more processor cores of the system.

In another possible embodiment of the method, the integrity component detects the occurrence of an event in a system component if deviations of the stored component data from predefined desired values occur, if limit or threshold values are exceeded or if inconsistencies occur.

In another possible embodiment of the method, the first interface of the system is formed by a network interface to a network of the system environment of the system.

In another possible embodiment of the method, the second interface of the system is formed by an interface, in particular a wireless interface, to the local or remote analysis unit and/or test unit.

The system, in particular an electronic system, has system components which internally communicate with one another via a common database and are connected to a system environment of the system via at least one first interface of the system. In particular, the system has an integrity component which isolates a system component of the system from the system environment of the system as soon as the integrity component of the system detects the occurrence of a particular event in the respective system component of the system, and an analysis component to which the integrity component transfers control of the isolated system component, whereupon the analysis component establishes a communication connection to an external analysis unit via a second interface of the system, which analysis unit analyzes the event which has occurred in the isolated system component using component data stored in the common database of the system.

In another possible embodiment of the system, the system components of the system are present in redundant form in the respective system.

In another possible embodiment of the system, the system is a distributed system.

In another possible embodiment of the system, the system is a real-time system.

In another possible embodiment of the system, the system environment of the system has a network which connects actuators and/or sensors to the first interface of the system.

In another possible embodiment of the system, the first interface of the system is a network interface to a network of the system environment.

In another possible embodiment of the system, the second interface of the system to the analysis unit and/or test unit is a wireless interface, in particular a mobile radio interface.

In another possible embodiment of the system, the system has a plurality of processors each having a plurality of processor cores, software components which are monitored by an integrity component being implemented on the processor cores.

Also described below is a vehicle, in particular a road vehicle, a rail vehicle or an aircraft, having at least one system, in particular an electronic system, having system components which internally communicate with one another via a common database and are connected to a system environment of the system via at least one first interface of the system. The system has an integrity component which isolates a system component of the system from the system environment of the system as soon as the integrity component of the system detects the occurrence of a particular event in the respective system component of the system, and an analysis component to which the integrity component transfers the control of the isolated system component, whereupon the analysis component establishes a communication connection to an external analysis unit via a second interface of the system, which analysis unit analyzes the event which has occurred in the isolated system component using component data stored in the common database of the system.

Also described is an automation installation having at least one system which controls actuators of the automation installation and evaluates sensor data provided by sensors of the automation installation.

### BRIEF DESCRIPTION OF THE DRAWINGS

These and other aspects and advantages will become more apparent and more readily appreciated from the following description of the exemplary embodiments of the method and system, taken in conjunction with the accompanying drawings of which:

FIG. 1 is a flowchart for illustrating an exemplary embodiment of a method;

FIG. 2 is a schematic diagram for illustrating an exemplary embodiment of a system.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

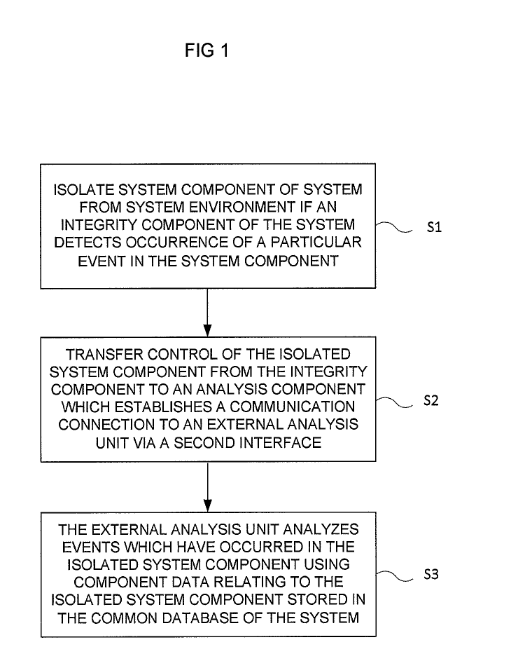

With reference to FIG. 1, in the exemplary embodiment illustrated, the method for analyzing events which occur in a system, in particular an electronic system having a plurality of system components. The system components of the system internally communicate with one another via a common database. Furthermore, the system components of the system are connected to a system environment of the system via at least one first interface. The system environment of the system may have, for example, a network which connects actuators and/or sensors via one or more first interfaces of the system.

As illustrated in the flowchart of FIG. 1, in S1, a system component of the system is first of all isolated from the system environment if an integrity component of the system detects the occurrence of a particular event in the system component. The integrity component can continuously monitor the occurrence of an event in a system component of the system on the basis of the components data stored in the common database of the system. If a particular event occurs in a system component of the system, the integrity component isolates this system component from the system environment and may keep the isolated system component active, if possible, at least until analysis of the event which has occurred in the system component has been concluded.

In S2, the integrity component will then transfer the control of the isolated system component to an analysis component of the system. This analysis component establishes a communication connection to an external analysis unit via a second interface of the system. The second interface of the system to the external analysis unit may be implemented by a wireless interface in one possible embodiment. This wireless interface is a mobile radio interface, in particular.

In S3 of the method, as illustrated in FIG. 1, the events which have occurred in the isolated system component are then analyzed by the external analysis unit using the component data relating to the isolated system component which are stored in the common database of the system. In this case, the analysis component of the system can provide the external analysis unit with the component data relating to the system component isolated in S1 which are stored in the common database of the system via the communication connection which has been established for the purpose of analyzing the event which has occurred in the isolated system component. Optionally, the external analysis unit can then deactivate at least the isolated system component of the system after the event which has occurred in the isolated system component has been analyzed. The deactivation can be carried out on the basis of the analysis result. Furthermore, in one possible embodiment, the analysis component can write definable component data to the common database of the system. The external analysis unit which is connected to the system, in particular the electronic system, via the second interface, for example a wireless interface, can cause the entire system to be restarted or can itself restart the entire system after the definable component data have been written to the common database of the system.

The system components of the system include both hardware and software components. The system may have, for example, a plurality of processors each having one or more processor cores, software components which are monitored by an integrity component being implemented on the processor cores. In one possible embodiment, the integrity component detects the occurrence of an event in a system component after detecting deviations of the stored component data relating to the respective system component from predefined desired values. Furthermore, the integrity component can detect the occurrence of an event if limit or threshold values are exceeded or if data inconsistencies occur. If such an event occurs, the integrity component can isolate the affected system component in S1 and can then transfer the control of the isolated system component to an analysis component of the system in S2. This analysis component then establishes a communication connection, for example via a wireless second interface, to the external analysis unit which analyzes the events which have occurred in the system component, for example the occurrence of a deviation of the stored component data from predefined desired values or the exceeding of limit or threshold values, in S3 using the component data relating to the isolated system component which are stored in the common database of the system.

The common database of the system may indicate the state of all system components at a particular time, for example at the time of a clock edge of a clock signal. The internal state of the system and of its system components includes, in particular, variables and signals which were interchanged in the last clock cycle between the system components. Furthermore, the database may also include module states of the system components, including the integrity component and the analysis component. In one possible embodiment, the common database is present as a data copy on all system components. In one possible embodiment, each system component of the system stores a data copy of the component data relating to all system components of the system, which component data are stored in the common database. A system component of the system may carry out write access only to its own component data relating to the respective system component within the common database.

In another possible embodiment of the method, a test component is additionally present or implemented in the system in addition to the integrity component and analysis component. This test component implemented in the system may carry out both write access and read access to the component data relating to all system components of the system, which component data are stored in the common database of the respective system. In one possible embodiment of the method, the analysis component of the system uses the available test component to carry out write and read access to component data relating to system components of the system, which component data are stored in the common database of the system. The test component present in the system may have a communication connection to an external test unit via the second interface of the system, for example a wireless interface, in one possible embodiment. In one possible embodiment of the method, the test component, as a system component of the system, deliberately causes events in one or more system components of the system, which events are detected by the integrity component of the system. Some of the system components of the system, including the integrity component, the analysis component and the possibly present test component, are formed by software components implemented on one or more processor cores of the system. In this case, some of the system components monitor external components of the system environment and may also control the external components. The system environment may have, for example, a network which connects actuators and/or sensors to one or more first interfaces of the system. The different system components of the system may be present in redundant form in one possible embodiment. In addition, the system may be a distributed system. In one possible embodiment, the system is also a real-time system which acquires and evaluates data in real time. The method illustrated in FIG. 1 can be used during system development of the system for test purposes and/or to search for causes of faults.

Furthermore, the method illustrated in FIG. 1 can also be carried out during its operative use of the system in order to analyze events. In comparison with conventional systems, an additional system component, namely the analysis component, is integrated in the system. In one possible embodiment, the analysis component may be implemented in the form of a software component. The system, in particular the electronic system, also executes the integrated analysis component, like any other system component, at particular times, for example when a clock edge occurs or when particular events occur, for example if a fault occurs. The integrated analysis component is therefore also permanently planned during system development and during system use and therefore does not impermissibly change the system behavior of the system, in particular a safety-critical electronic system. In the system, the integrated analysis component is connected to an external analysis unit not belonging to the system itself via a separate communication connection or communication line. Another special system component which is integrated in the system is the integrity component which detects system faults and system inconsistencies.

FIG. 2 schematically shows a simple exemplary embodiment of a system in which the method for analyzing events can be carried out.

In the exemplary embodiment schematically illustrated in FIG. 2, the system includes a platform core having a plurality of DCC (data communication computer) units which can be connected to one another, for example in the form of a ring, via network interfaces. The system has a certain number of DCC units and a plurality of compliant or non-compliant sensors or actuators AIS. Each DCC unit may contain a memory and a software module in which an integrity component and an analysis component are implemented. An external analysis unit AE is connected to the analysis components implemented in the DCC units and their software modules via a further interface illustrated using dashed lines, for example a wireless interface.

In one possible embodiment, the system components communicate via a central common database. The system components store component states and events or signals in this central common database. If there is a test component, this can have read and write access to the central common database. As soon as the integrity component detects system faults or a fault in a system component, it isolates the affected system component from the system environment. The integrity component then transfers system control to the analysis component. The analysis component then informs the analysis unit of the system state. The analysis unit also uses the analysis component to transmit component states and events from the central data area or the central database. The analysis unit then decides on the further process, for example whether the faulty system component or even the entire system is switched off or whether a defined state is loaded into the central data area or the central database and the system is restarted.

In one possible embodiment, the analysis component can continuously supply data to the external analysis unit or can transmit data to the analysis unit (logging) if a fault or an event occurs.

In the method, the affected system component(s) is/are isolated after a fault or a particular event occurs but is/are kept active, with the result that further analyses can be carried out on the system, for example by an analysis program or an engineer, or in order to change the faulty behavior of the system and to be able to then reactivate the system. In the method, a central data area or a central database of the system is used for this purpose. This central database is used to decouple system components of the system from one another since communication between the system components takes place only via the central database. Furthermore, component states and component functions of the system components are decoupled by transferring state variables to the central data area or the central database.

In one possible embodiment of the method, there is a specialized test component which can read the central database and can write to this database but is otherwise handled by the system like any other system component. In this manner, the specialized test component and a possibly connected test unit cannot impermissibly influence the system behavior of the system.

The method can be seamlessly combined with known logging techniques. The method can support automatic tests of the system as well as interactive, exploratory testing. The method can also be used in scenarios in which the causes of faults or system behaviors are not known in advance.

In one possible embodiment of the system, the system is integrated in a vehicle. In one possible embodiment, this vehicle is a road or rail vehicle or an aircraft. It is also possible for the system to be provided in an automation installation, the automation installation controlling actuators and evaluating sensor data provided by sensors of the automation installation.

The method or system can be used, for example, in the context of vehicle controllers, in particular in electric vehicles, in particular for the purpose of testing hardware-specific/software-specific non-functional safety services which are intended to be automatically provided for vehicle functions by the redundant central hardware/software platform or the system. In order to detect faults and ensure the availability of the system or electronic system, the central hardware/software platform of the electric vehicle is redundant and monitors and compares the states of redundant channels. This can be carried out for each likewise redundant computer of this hardware/software platform. If, for example, the integrity component of this hardware/software platform determines intolerable inconsistencies or faults, the affected part of the controller or the affected system component is isolated and a redundant system component then undertakes its functions since reliable operation is no longer possible with the faulty control part or the faulty system component. With the method, not only can the behavior of a system component or of the entire system be concomitantly logged until a faulty system component is switched off, but the faulty system component is also isolated and continues to be available to the test system, so that it can be analyzed and possibly even repaired during operational use, for example inside a vehicle.

In one possible embodiment, not only the faulty affected system component of the system but rather the entire system can be isolated in the described manner in the event of a fault. During field operation, that is to say during operational use of the system, the extent to which the system or the system component can be isolated depends on the respective application.

For use in mass-produced vehicles, the method can be used as follows. After a faulty system component or a faulty subsystem has been isolated, the test component independently transmits the system state present at the time of the fault to a data memory which is subsequently analyzed by a vehicle service in a known manner or is transmitted by the vehicle service to an external, e.g., wirelessly connected, test or analysis unit. This test or analysis unit may be installed by the vehicle manufacturer, for example, in order to carry out diagnoses or repairs. In the method, a separate communication connection is available for transmitting data. Furthermore, the test component, either independently or on the instruction of the test unit, can carry out a restart with a defined state and can check whether the subsystem or the affected system component can be used again after the system has been re-initialized.

The method and system are suitable, in particular, for highly available, safety-critical and redundant distributed real-time systems. During development and even after development, these systems impose high demands on the traceability and adjustment of faults and on the analysis of the causes of faults.

However, the method and system are not restricted to use in redundant systems or in vehicles, but rather can be integrated in a wide variety of electronic systems. If the system is not redundant, the system functions of the affected system components are no longer available after disconnection caused by a fault. However, the system state and also the previous system sequence can still be completely analyzed using the method. Under certain circumstances, a system restored by the analysis can even continue its work depending on the type of fault which has occurred.

In another possible embodiment of the method and of the system, the analysis and/or test component and the associated communication connection to the test and/or analysis unit may in turn be redundant. This provides the advantage that the method and system still function even if the test component or analysis component and the associated test and/or analysis unit themselves are faulty.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-21. (canceled)

22. A method for analyzing events which occur in a system having system components which internally communicate with one another via a common database and are connected to a system environment of the system via at least one first interface of the system, comprising:
isolating a system component of the system from the system environment when an integrity component of the system detects occurrence of a particular event in the system component;
transferring control, after said isolating, of the system component from the integrity component to an analysis component of the system;
establishing an analysis communication connection between the analysis component and an external analysis unit via a second interface of the system; and
analyzing the particular event which has occurred in the system component by the external analysis unit using component data relating to the system component stored in the common database of the system.

23. The method as claimed in claim 22, further comprising providing, by the analysis component, the external analysis unit with the component data relating to the system component which are stored in the common database of the system via the analysis communication connection which has been established for the purpose of analyzing the event which has occurred in the system component.

24. The method as claimed in claim 22, further comprising after said analyzing at least one of
deactivating, by the external analysis unit, at least the system component after said isolating thereof; and
writing definable component data to the common database of the system.

25. The method as claimed in claim 24, further comprising the external analysis unit causing the system to be restarted after writing the definable component data, if written to the common database of the system.

26. The method as claimed in claim 22, further comprising storing, by the system components in the common database, a data copy of the component data relating to all system components of the system.

27. The method as claimed in claim 22,
further comprising continuously monitoring, by the integrity component, occurrence of events in at least one system component of the system based on the component data stored in the common database of the system, and
wherein the integrity component, when the particular event occurs in the system component of the system, isolates the system component from the system environment of the system and keeps the system component active at least until analysis of the event which has occurred in the system component has been completed by the external analysis unit.

28. The method as claimed in claim 22, further comprising performing, by a test component implemented in the system, both write access and read access to the component data stored in the common database of the system and relating to all system components of the system.

29. The method as claimed in claim 28, further comprising the analysis component of the system using the test component of the system to perform the write access and read access to the component data relating to the system components of the system.

30. The method as claimed in claim 28, wherein the test component in the system has a test communication connection to an external test unit via the second interface of the system.

31. The method as claimed in claim 28, further comprising:
causing, by the test component, events in at least one system component of the system; and
detecting, by the integrity component of the system, the events caused by the test component.

32. The method as claimed in claim 22, further comprising at least one of controlling and monitoring external components of the system environment of the system by the system components of the system, the external components of the system environment of the system having at least one of actuators and sensors connected to the first interface of the system via a network that are at least one of controlled and monitored by the system components of the system.

33. The method as claimed in claim 22, further comprising implementing at least some of the system components of the system, including the integrity component, the analysis component and a test component, in processor cores of the system by software.

34. The method as claimed in claim 22, further comprising detecting, by the integrity component, occurrence of the particular event when at least one of deviations of the component data from predefined desired values occur, limit or threshold values are exceeded or inconsistencies occur.

35. The method as claimed in claim 22,
wherein the first interface of the system is a network interface to a network of the system environment of the system, and
wherein the second interface of the system is a wireless interface to at least one of a local analysis unit. a remote analysis unit and a test unit.

36. An electronic system having system components internally communicating via a common database and connected to a system environment of the electronic system and an external analysis unit, comprising:
first and second interfaces;
an integrity component that isolates a system component of the electronic system from the system environment as soon as the integrity component detects occurrence of a particular event in the system component; and
an analysis component receiving control of the system component from the integrity component after isolation thereof and establishing a communication connection to the external analysis unit via the second interface, the external analysis unit analyzing the event which has occurred in the system component using component data stored in the common database.

37. The system as claimed in claim 36, the system being a distributed system, in particular a distributed real-time system, which has redundant system components.

38. The system as claimed in claim 36, wherein the system environment of the electronic system has a network connecting at least one of actuators and sensors to the first interface.

39. The system as claimed in claim 36, wherein the system environment includes a network,
wherein the first interface is a network interface to the network of the system environment, and
wherein the second interface is a mobile radio interface connected to at least one of the external analysis unit and a test unit included in the system components.

40. The system as claimed in claim 36,
further comprising a plurality of processors, each having a plurality of processor cores executing software components, and
wherein said integrity component is implemented on at least one of the processor cores and monitors the software components.

41. A vehicle having a vehicle environment, comprising
an analysis unit; and
an electronic system having system components internally communicating via a common database and connected to the vehicle environment and said analysis unit, the system including:
first and second interfaces;
an integrity component that isolates one of the system components of the electronic system from the vehicle environment as soon as the integrity component detects occurrence of a particular event in the one of the system component; and
an analysis component receiving control of the one of the system components from the integrity component, and establishing a communication connection to the analysis unit via the second interface, the analysis unit analyzing the event which has occurred in the one of the system components using component data stored in the common database.

42. The vehicle as claimed in claim 42, wherein the vehicle is one of a road vehicle, a rail vehicle and an aircraft.

43. An automation installation, comprising:
actuators;
sensors producing sensor data;
an analysis unit; and
an electronic system, connected to said actuators, said sensors and said analysis unit, controlling said actuators and evaluating the sensor data provided by said sensors, said electronic system including
first and second interfaces, and
system components internally communicating via a common database, including
an integrity component that isolates one of the system components of the electronic system upon detection of an occurrence of a particular event in the system component by the integrity component, and
an analysis component receiving control of the one of the system components from the integrity component after isolation and establishing a communication connection to the analysis unit via the second interface, the analysis unit analyzing the event which has occurred in the one of the system component using component data stored in the common database.
